(19) United States
(12) Patent Application Publication
(10) Pub. No.: US 2026/0037074 A1
(43) Pub. Date: Feb. 5, 2026

(54) PROJECTOR AND CONTROL METHOD THEREFOR

(71) Applicant: SAMSUNG ELECTRONICS CO., LTD., Suwon-si (KR)

(72) Inventors: Sunyoung KIM, Suwon-si (KR); Hyuntae Kim, Suwon-si (KR); Jihae Lim, Suwon-si (KR); Nakwon Choi, Suwon-si (KR); Soyon You, Suwon-si (KR); Jaewon Jung, Suwon-si (KR)

(73) Assignee: SAMSUNG ELECTRONICS CO., LTD., Suwon-si (KR)

(21) Appl. No.: 19/354,438

(22) Filed: Oct. 9, 2025

Related U.S. Application Data
(63) Continuation of application No. PCT/KR2024/003828, filed on Mar. 27, 2024.

(30) Foreign Application Priority Data
May 17, 2023 (KR) 10-2023-0063765

(51) Int. Cl. G06F 3/01; G06F 3/0484

(52) U.S. Cl. CPC G06F 3/017; G06F 3/0484

(57) ABSTRACT

A projector includes: an image generator configured to generate an image; a projection adjuster configured to adjust a projection area onto which the image is projected; a sensor configured to detect a gesture input for the projection area; memory storing instructions; and a processor configured to execute the instructions, wherein the instructions, when executed by the processor, may cause the projector to, based on the gesture input being a division command for the projection area, control the projection adjuster such that the image is projected onto divided projection areas as divided.

### CROSS-REFERENCE TO RELATED APPLICATIONS

This application is a continuation application of International Application No. PCT/KR2024/003828, filed on Mar. 27, 2024, which is based on and claims priority to Korean Patent Application No. 10-2023-0063765, filed on May 17, 2023, in the Korean Intellectual Property Office, the disclosures of which are incorporated by reference herein in their entireties.

### BACKGROUND

### 1. Field

The disclosure relates to a projector and a controlling method thereof, and more particularly, to a projector capable of touch interaction and a controlling method thereof.

### 2. Description of Related Art

Generally, a projector is an optical device for enlarging and projecting images, videos, text, and the like onto a screen through a lens.

With the advancement of technology enabling high-definition displays, large-screen projection television (TVs), plasma display panel (PDP) TVs, projectors, and the like are gaining attention as display devices, in addition to the conventional direct-view type display devices. In particular, projectors have the benefit of being able to form a larger screen compared to other display devices, and thus their use has been gradually expanding beyond conventional uses, such as serving as a display device for a personal computer (PC) for business applications, including seminar presentations, to also serving as home display devices.

Recently, projectors have become capable of touch interaction, in which a user's touch or other gestures on a projection area are recognized to enable interaction. However, conventional touch interaction has not been significantly different from operating with a remote control, such as selecting a specific menu within the projected screen.

### SUMMARY

Provided is a projector capable of recognizing a gesture input for a projection area projected from the projector and dividing a single projection area into a plurality of projection areas such that a plurality of users may each view a desired images.

Furthermore, provided is a projector capable of detecting an object around the projector and projecting an image onto an area excluding the object.

Further still, provided is a projector capable of detecting an object around the projector and projecting an image onto an edge or inside of the object, thereby allowing a user to experience an aesthetic impression.

The technical objectives of the present disclosure are not limited to the above, and other objectives that are not described above will be clearly understood by those skilled in the art from the above detailed description.

According to an aspect of the disclosure, a projector includes: an image generator configured to generate an image; a projection adjuster configured to adjust a projection area onto which the image is projected; a sensor configured to detect a gesture input for the projection area; memory storing instructions; and a processor configured to execute the instructions, wherein the instructions, when executed by the processor, may cause the projector to, based on the gesture input being a division command for the projection area, control the projection adjuster such that the image is projected onto divided projection areas as divided.

According to an aspect of the disclosure, a projector includes: an image generator configured to generate an image; a projection adjuster configured to adjust a projection area onto which the generated image is projected; a sensor configured to detect a gesture input for the projection area; a detector configured to detect an object; memory storing instructions; and a processor configured to execute the instructions, wherein the instructions, when executed by the processor, cause the projector to control, based on the gesture input, the projection adjuster to position the projection area at one of an edge of the object or an inside of the object.

According to an aspect of the disclosure, a method of controlling a projector, includes: generating an image; projecting the image onto a projection area; detecting a gesture input for the projection area; and based on the gesture input being a division command for the projection area, dividing the projection area such that the image is projected onto divided projection areas.

### BRIEF DESCRIPTION OF THE DRAWINGS

The above and other aspects, features, and advantages of certain embodiments of the present disclosure may be more apparent from the following description taken in conjunction with the accompanying drawings, in which:

FIGS. 1A-1B are diagrams illustrating a projector projecting an image according to one or more embodiments;

FIG. 2 is a diagram for describing touch interaction of a projector according to an embodiment;

FIG. 3 is a control block diagram illustrating a projector according to an embodiment;

FIG. 4 is a flowchart illustrating division of a projection area according to an embodiment;

FIG. 5 is a diagram illustrating projection areas that have been divided according to an embodiment;

FIGS. 6A to 6C are diagrams illustrating various gestures for dividing a projection area according to an embodiment;

FIGS. 7A and 7B are diagrams illustrating a plurality of users viewing images projected onto respective divided projection areas according to an embodiment;

FIGS. 8A and 8B are diagrams illustrating a projection area being divided at different ratios according to an embodiment;

FIG. 9 is a diagram illustrating a change of an image of a part of divided projection areas according to an embodiment;

FIGS. 10A and 10B are diagrams illustrating gestures for adjusting a projection area according to an embodiment;

FIGS. 11A and 11B are diagrams illustrating the division of a projection area into two or more areas according to an embodiment;

FIG. 12 is a flowchart for describing the division of a projection area based on an image captured by a camera according to an embodiment;

FIG. 13 is a flowchart illustrating the merging of divided projection areas according to an embodiment;

FIG. 14 is a diagram illustrating projection areas being merged according to an embodiment;

FIG. 15 is a diagram illustrating a plurality of projection areas, in which different images are projected, being merged according to an embodiment;

FIGS. 16A to 16C are diagrams illustrating various examples of adjusting a projection area according to an embodiment;

FIG. 17 is a diagram illustrating a user interface for adjusting a projection area according to an embodiment;

FIG. 18 is a diagram illustrating a user interface for adjusting a projection area according to an embodiment;

FIG. 19 is a flowchart illustrating adjustment of a projection area based on a detected object according to an embodiment;

FIG. 20 is a diagram illustrating adjustment of a projection area based on a detected object according to an embodiment;

FIG. 21 is a flowchart illustrating projection of an image based on a detected object according to another embodiment;

FIGS. 22A and 22B are diagrams illustrating an image being projected onto the edge or inside of an object according to an embodiment; and

FIG. 23 is a diagram illustrating selection of an image to be projected onto the edge or inside of an object according to an embodiment.

### DETAILED DESCRIPTION

The embodiments described in the present specification and the configurations shown in the drawings are only examples of preferred embodiments of the present disclosure, and various modifications may be made at the time of filing of the present disclosure to replace the embodiments and drawings of the present specification.

Further, identical symbols or numbers in the drawings of the disclosure denote components or elements configured to perform substantially identical functions.

The terms used herein are for the purpose of describing the embodiments and are not intended to restrict and/or to limit the present disclosure. For example, the singular expressions herein may include plural expressions, unless the context clearly dictates otherwise. In addition, the terms “comprises,” “includes,” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that when an element is referred to as being “connected,” or “coupled,” to another element, it can be directly connected or coupled to the other element or intervening elements may be present.

It will be understood that, although the terms “first”, “second”, etc. may be used herein to describe various components, these components should not be limited by these terms. These terms are only used to distinguish one component from another. For example, without departing from the scope of the present disclosure, the first component may be referred to as a second component, and similarly, the second component may in addition be referred to as a first component. The term “and/or” includes combinations of one or all of a plurality of associated listed items.

As used herein, expressions such as “at least one of,” when preceding a list of elements, modify the entire list of elements and do not modify the individual elements of the list. For example, the expression, “at least one of A, B, or C,” should be understood as including only A, only B, only C, both A and B, both A and C, both B and C, or all of A, B, and C.

Hereinafter, embodiments according to the present disclosure will be described with reference to the accompanying drawings.

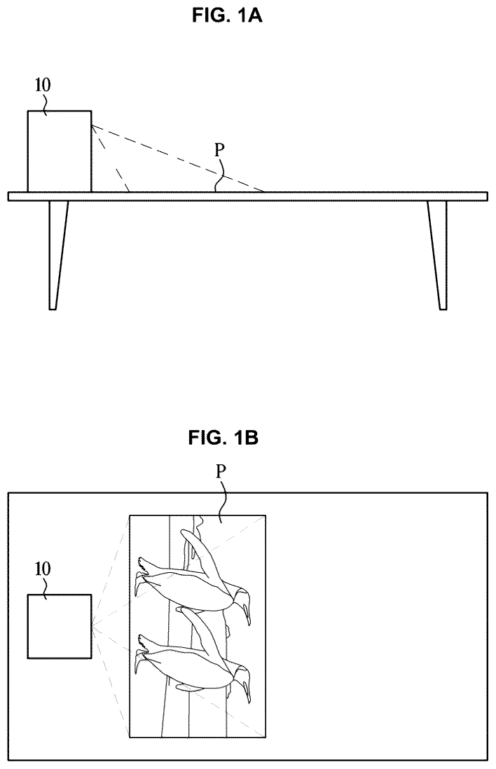

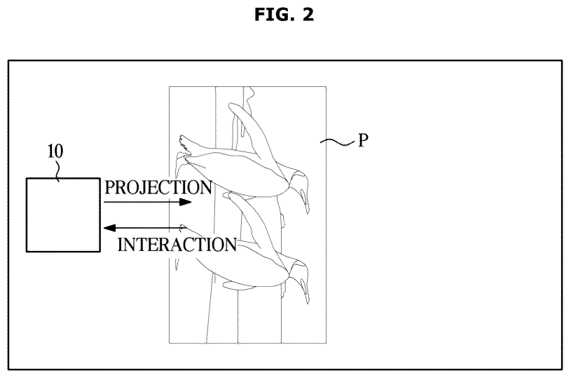

FIGS. 1A-1B are diagrams illustrating a projector projecting an image according to an embodiment, and FIG. 2 is a diagram for describing touch interaction of a projector according to an embodiment.

A projector 10 may project an image or the like toward a surface, such as a wall surface or a screen located in front of the projector 10, or may project an image or the like toward a surface near the projector 10, such as a floor surface, a table, or the like. As illustrated in FIG. 1A-1B, the projector 10 according to the disclosure is described by way of example as a projector that projects toward a surface, such as a table. The operations of the disclosure to be described below may also be applied to a projector 10 that projects toward the front.

The projector 10 may project a predetermined image onto a projection area P of the floor surface. Various images, such as photos, videos, or text generated by the projector 10 may be projected onto the projection area P.

The projector 10 may, upon detecting a gesture input for the projection area P, receive a signal corresponding to the detected gesture input, and perform various control operations based on the received signal.

The gesture may include various actions, such as a touch. When a touch occurs on the projection area P, various control operations may be performed according to a signal corresponding thereto.

Hereinafter, a detailed description will be provided of various embodiments for controlling a projected image based on a gesture input, such as a touch, in a projector 10 capable of touch interaction.

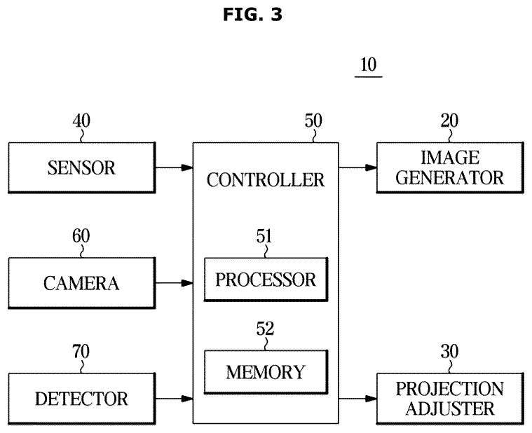

FIG. 3 is a control block diagram illustrating a projector according to an embodiment.

According to an embodiment, the projector 10 may include an image generator 20, a projection adjuster 30, a sensor 40, and a controller 50, and the controller 50 may include at least one processor 51 and memory 52. In the embodiments described below, the projector 10 may further include a detector 70 and a camera 60.

The image generator 20 may generate an image to be projected onto the projection area P in the projector 10. The image may include photos, videos, text, and the like.

The projection adjuster 30 may adjust and project the image generated by the image generator 20, and may adjust the projection area P. The projection adjuster 30 may include a lens.

The sensor 40 may detect a gesture input for the projection area P. For example, the sensor 40 may detect a signal caused by a gesture input for the projection area P. In addition, the sensor 40 may include one or more sensors.

The controller 50 may include the memory 52 for storing a control program and control data for controlling the projection adjuster 30, and a processor 51 for generating control signals according to the control program and control data stored in the memory 52. The memory 52 and the processor 51 may be provided as single part or separately.

The memory 52 may store instructions or programs and data for controlling the projection adjuster 30. The memory 52 may include a volatile memory, such as a static random access memory (S-RAM) or a dynamic RAM (D-RAM) for temporarily storing data. In addition, the memory 52 may include a non-volatile memory, such as a read only memory (ROM), an erasable programmable ROM (EPROM), or electrically erasable ROM (EEPROM) for long-term data storage.

The processor 51 may include various logic circuits and arithmetic circuits, process data according to programs provided from the memory 52, and generate control signals based on the processing result.

The controller 50 may control the projection adjuster 30 to adjust the projected image and the projection area P based on the detection result of the sensor 40.

As described below, the controller 50 may, in response to a gesture input being a division command for the projection area P, control the projection adjuster 30 such that an image is projected onto divided projection areas. That is, the controller 50 may control the projection adjuster 30 such that a single projection area P is divided into a plurality of projection areas.

Hereinafter, various operations for adjusting the projection area P, dividing a single projection area P into a plurality of projection areas, or adjusting each of the divided projection areas will be described in detail.

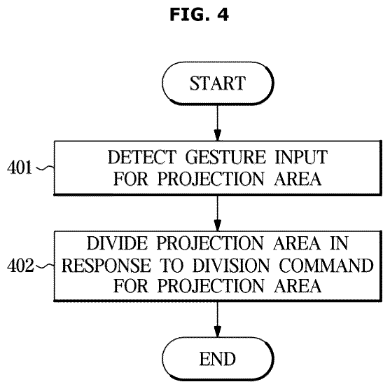

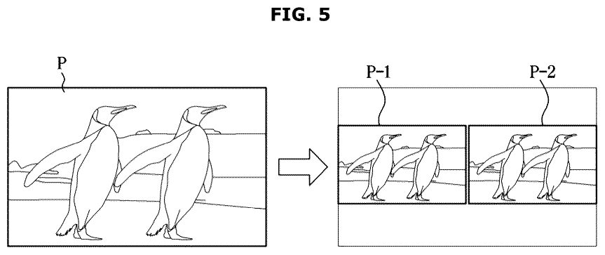

FIG. 4 is a flowchart illustrating division of a projection area according to an embodiment, and FIG. 5 is a diagram illustrating projection areas that have been divided according to an embodiment.

When a plurality of users view a video projected through the projector 10, a single projected image may be divided into a plurality of images, allowing each user to view the video in a position, size, orientation, and angle that is comfortable to the user. Additionally, even for a single user, a single image may be divided into a plurality of images such that the user may view a plurality of images.

In some embodiments, the user may divide a single projection area P into a plurality of projection areas P-1 and P-2 by performing a predetermined gesture on the projection area P.

Specifically, the sensor 40 may detect a gesture input for the projection area P (401), and the controller 50 may, in response to the gesture input being a division command for the projection area P, control the projection adjuster 30 such that images are projected onto divided projection areas P-1 and P-2 (402).

That is, as shown in FIG. 5, a single projection area P may be divided into two projection areas P-1 and P-2, and an image may be projected onto each of the projection areas P-1 and P-2. In this case, an image being projected onto the single projection area P may be split, or as shown in FIG. 5, the same image as that projected onto the single projection area P may be projected onto each of the two projection areas P-1 and P-2. Although FIG. 5 illustrates a case in which a single projection area P is divided into two projection areas P-1 and P-2, this is merely an example, and a single projection area P may be divided into two or more projection areas P-1, P-2, . . . , and P-n.

As will be described below, each of the divided projection areas P-1 and P-2 may be individually adjusted for size, position, angle, and the like such that a plurality of users may adjust images projected according to their preference.

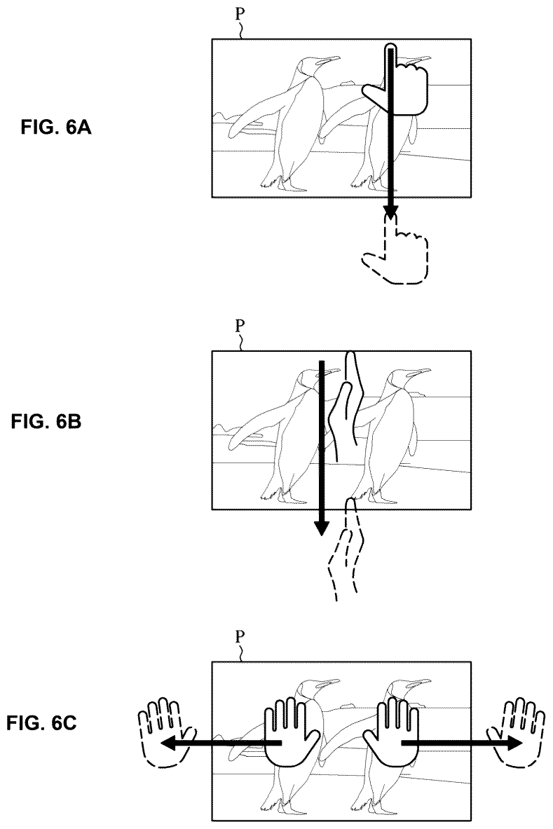

FIGS. 6A to 6C are diagrams illustrating various gestures for dividing a projection area according to an embodiment.

As described above, the projection area P may be divided by a gesture input for the projection area P.

The gesture for dividing the projection area P may be defined in various forms. For example, as shown in FIG. 6A, the gesture input may be a finger drawing a certain line on the projection area P, and when the gesture of drawing the certain line on the projection area P with the finger is detected, the projection area P may be divided.

Also, as shown in FIG. 6B, the gesture input may be a side of the hand drawing a certain line on the projection area P, and when the gesture of drawing the certain line on the projection area P with the side of the hand is detected, the projection area P may be divided.

In some embodiments, as shown in FIG. 6C, the gesture input may be a movement of pushing the projection area P outward with both palms, and when the gesture of pushing the projection area P outward with both palms is detected, the projection area P may be divided. The gestures illustrated are merely examples of gestures for dividing the projection area P, and various types of gestures for dividing the projection area P may be defined.

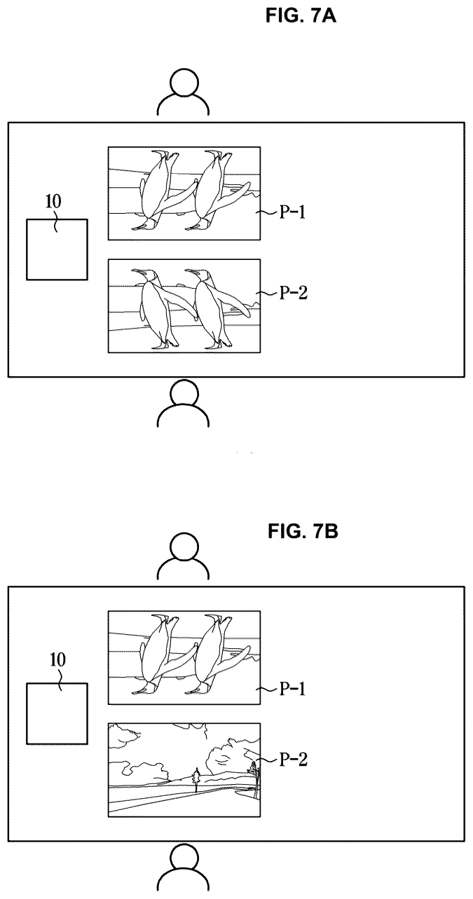

FIGS. 7A and 7B illustrate two users viewing images projected onto respective divided projection areas (projection areas P-1 and P-2). The user may be two or more users and the projection area P may be two or more projection areas, as described above.

Referring to FIG. 7A, a single projection area P may be divided into two projection areas P-1 and P-2, allowing each user to view an image projected onto the respective projection area P. In this case, the divided projection areas P-1 and P-2 may each have the same image as the image previously projected onto the projection area P and thus the two users may view the same image.

Referring to FIG. 7B, each user may adjust the respective divided projection areas P-1 and P-2 to also change the image being projected. Accordingly, different images may be projected onto the respective projection areas P-1 and P-2. The adjustment of each of the projection areas P-1 and P-2 will be described below. For example, as shown in FIG. 7B, the projection area P-1 may display the image that was previously projected onto the projection area P and the projection area P-2 may be adjusted to display a different image than the image that was previously projected onto the projection area P.

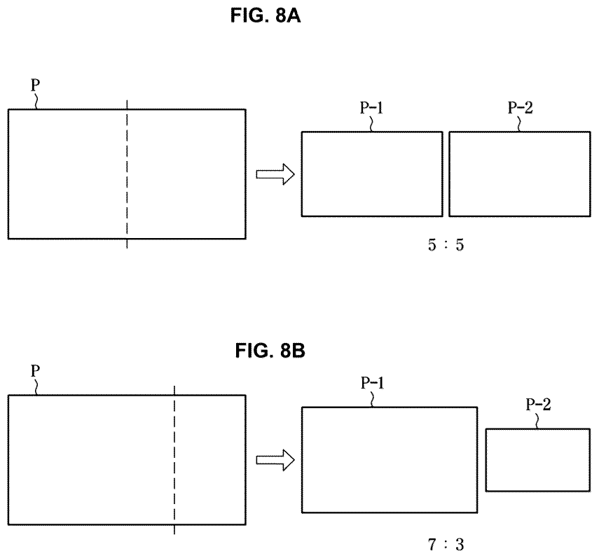

FIGS. 8A and 8B are diagrams illustrating a projection area being divided at different ratios according to an embodiment.

When the projection area P is divided, for example as shown in FIGS. 6A and 6B, the ratio in which the projection area P is divided may be determined according to the position of the gesture input. For example, when the gesture of drawing a line is inputted to divide the projection area P, the ratio in which the projection area P is divided may correspond to the position in which the line is drawn.

That is, the controller 50 may, in response to the gesture input being a division command for the projection area P, controls the projection adjuster 30 such that images are projected onto projection areas P-1 and P-2 divided at different ratios.

As shown in FIG. 8A, when a vertical line is drawn at the center of the projection area P, a single projection area P may be divided into two projection areas P-1 and P-2 having the same ratio.

As shown in FIG. 8B, when a line is drawn in a region shifted to the right from the center of the projection area P, it can be seen that the left side of the drawn line is wider than the right side. Accordingly, a single projection area may be divided into projection areas having different ratios. For example, a single projection area may be divided at a ratio of 7:3 as shown in FIG. 8B.

Although FIGS. 8A-8B illustrate cases of drawing a line in the vertical direction on the projection area P, the disclosure is not limited thereto, and the ratio of divided projection areas P-1 and P-2 may be determined even when the projection area P is divided by various other forms of gesture.

By dividing the projection area P into different ratios as described above, user convenience may be increased.

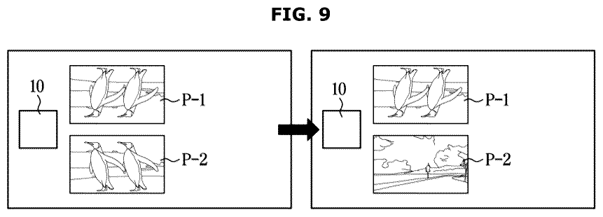

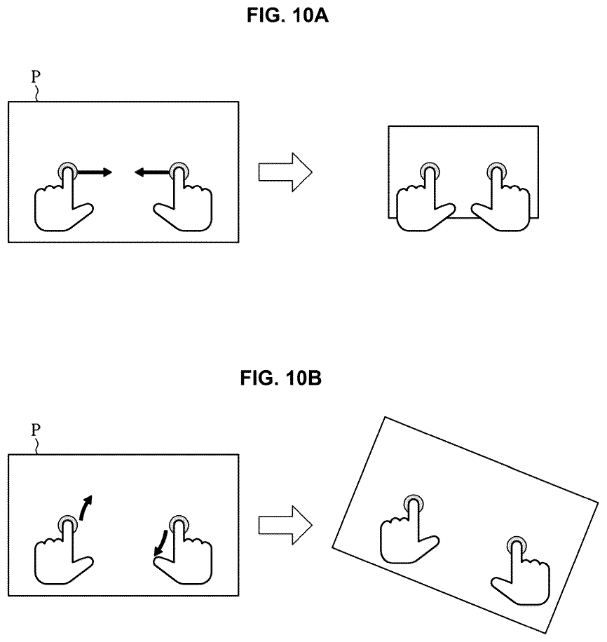

FIG. 9 is a diagram illustrating a change of an image of a part of divided projection areas according to an embodiment, and FIGS. 10A and 10B are diagrams illustrating gestures for adjusting a projection area according to an embodiment.

When a single projection area P is divided into a plurality of projection areas P-1 and P-2 by the above-described gesture input, and an image is projected onto each of the projection areas P-1 and P-2, a user may adjust each of the projection areas P-1 and P-2 through a gesture input for adjusting the projection area P-1 or P-2. That is, the divided projection areas P-1 and P-2 may be adjusted independently of each other.

That is, the controller 50 may, based on a gesture input for each of the divided projection areas P-1 and P-2, control the projection adjuster 30 to adjust each of the divided projection areas P-1 and P-2.

Referring to FIG. 9, the adjustment may be performed on each of the divided first projection area P-1 and the second projection area P-2. Various adjustments, such as adjusting the size of each projection area P-1 and P-2, changing the position of each projection area P-1 and P-2, or rotating each projection area P-1 and P-2 may be performed. FIG. 9A illustrates performing an adjustment that changes the image projected onto the second projection area P-2. The same image as the image projected onto the projection area P before the division has been projected onto the divided projection areas P-1 and P-2, but the image projected onto the second projection area P-2 may be changed through a gesture input for the second projection area P-2. It is also possible to change only the image projected onto the first projection area P-1 and/or to change the images projected onto both the first and second projection areas P-1 and P-2.

Referring to FIGS. 10A-10B, a gesture for adjusting each of the divided projection areas P-1 and P-2 may be input.

As shown in FIG. 10A, when an arbitrary area is touched with two points and then the two points are moved in a direction closer to each other, the size of the projection area P may be reduced. Conversely, when an arbitrary area is touched with two points and then the two points are moved in a direction away from each other, the size of the projection area P may be increased. For example, as shown in FIG. 10A, size of the projection area P may be adjusted by two hands moving with respect to each other, or the two points may be two fingers on one hand and the projection area P may be adjusted by the two fingers moving with respect to each other, such as a pinching motion or a spreading motion.

As shown in FIG. 10B, when an arbitrary area is touched with two points and the two points are moved in a direction in which the projection area P is to be rotated, the projection area P may be rotated. For example, as shown in FIG. 10B, the projection area P may be rotated by two hands moving in a rotation direction, or two points may be two fingers on one hand moving in a rotation direction.

By controlling each of the divided projection areas P-1 and P-2 as described above, each user may view an image in a preferred environment.

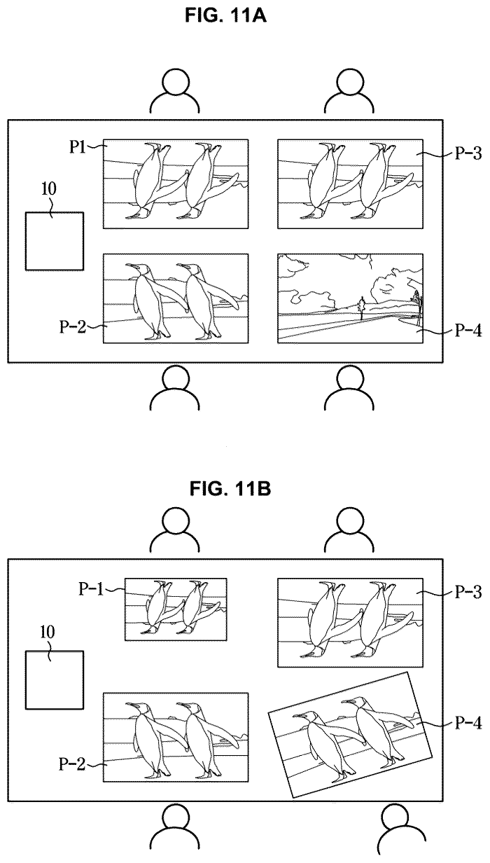

FIGS. 11A and 11B are diagrams illustrating the division of a projection area into two or more areas according to an embodiment.

Referring to FIGS. 11A and 11B, it can be seen that four users are located around a table, and the projection area P projected toward the table surface is divided into 4 projection areas P-1, P-2, P-3, and P-4. As described above, a single projection area P may be divided into two or more projection areas, thereby allowing a plurality of users to each view a preferred projected image in a preferred environment of the user.

As shown in FIG. 11A, the image projected onto the fourth projection area P-4 may be changed such that an image different from the projected image before the division may be viewed, and as shown in FIG. 11B, the size, position, angle, and the like of each of the projection areas P-1, P-2, P-3, and P-4 may be adjusted such that the each projected image may be viewed in a preferred environment of the user.

Specifically, it can be seen that the first projection area P-1 is reduced in size by inputting a gesture for reducing the size of the projection area, and the fourth projection area P-4 is rotated by inputting a gesture for rotating the projection area.

As described above, a single projection area P may be divided into two or more projection areas P-1, P-2, P-3, and P-4 and the projection areas P-1, P-2, P-3, and P-4 may be independently controlled, and thus a plurality of users may each view a projected image in a preferred environment of the user.

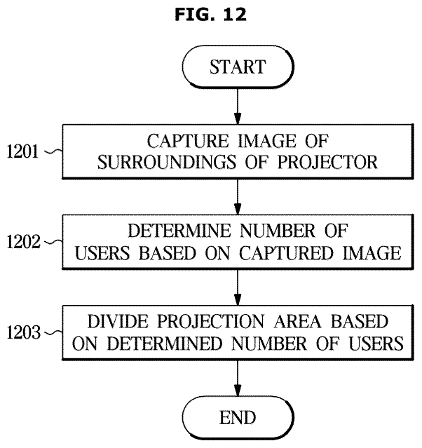

FIG. 12 is a flowchart for describing the division of a projection area based on an image captured by a camera according to an embodiment.

The projector 10 may further include a camera 60 for capturing an image of the surroundings of the projector 10. The camera 60 may capture an image of users around the projector 10 (1201), and the controller 50 may identify the number of users based on the image captured by the camera 60 (1202).

The controller 50 may control the projection adjuster 30 such that images are projected onto the divided projection areas P-1 and P-2 based on the determined number of users.

That is, when there are two persons around the projector 10 as shown in FIG. 7, the projection adjuster 30 may be controlled to divide the projection area P into two projection areas P-1 and P-2, and when there are four persons as shown in FIG. 11, the projection adjuster 30 may be controlled to divide the projection area P into four projection areas P-1, P-2, P-3, and P-4.

Although a separate gesture may be input to divide the projection area P, the projection area P may be automatically divided based on the number of users captured through the camera 60 through a specific input. For automatic division of the projection area P through capturing by the camera 60, an input, such as touching a user interface separately displayed on the projection area P may be performed.

When a user desires to divide the projection area P, the projection area P may be automatically divided based on the number of users captured by the camera 60 without a separate gesture input, thereby improving user convenience.

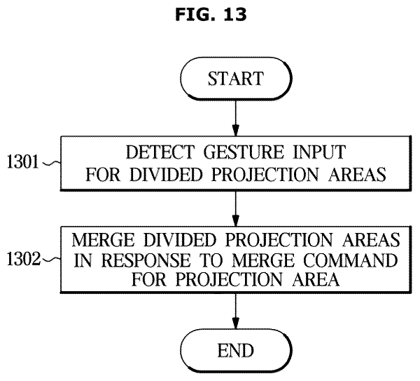

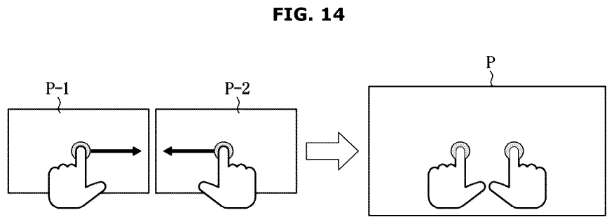

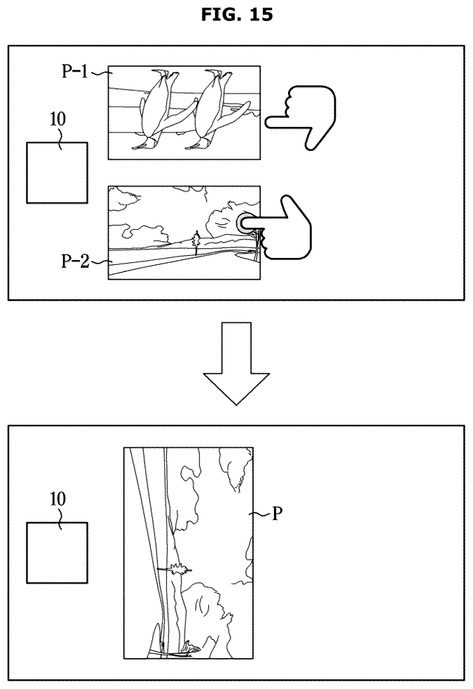

FIG. 13 is a flowchart illustrating the merging of divided projection areas according to an embodiment. FIG. 14 is a diagram illustrating projection areas being merged according to an embodiment. FIG. 15 is a diagram illustrating a plurality of projection areas, in which different images are projected, being merged according to an embodiment.

The above description pertains to a case in which a single projection area P is divided into a plurality of projection areas and control is performed on each projection area. In some cases, there is a need to merge the divided plurality of projection areas back into a single projection area P. Accordingly, a process of merging the divided projection areas is described.

When a user inputs a predetermined gesture on the divided projection areas P-1 and P-2, the controller 50 may control the projection adjuster 30 such that the divided projection areas P-1 and P-2 are merged.

That is, the sensor 40 may detect a gesture input for the divided projection areas P-1 and P-2 (1301), and the controller 50 may, in response to the gesture input being a merging command for the divided projection areas P-1 and P-2, control the projection adjuster 30 such that the divided projection areas P-1 and P-2 are merged into a single projection area P (1302).

Referring to FIG. 14, a predetermined gesture may be input to the divided projection areas P-1 and P-2 to merge the divided projection areas P-1 and P-2. For example, arbitrary points of each of the divided projection areas P-1 and P-2 are touched and moved in a direction in which the points are merged, the divided projection areas P-1 and P-2 may be merged into one.

Such a gesture is merely an example, and various gesture inputs for merging the divided projection areas P-1 and P-2 may be defined.

When the divided projection areas P-1 and P-2 project the same image, the corresponding image may be projected on the merged projection area P.

When the divided projection areas P-1 and P-2 project different images as shown in FIG. 15, an image having been projected onto the projection area P-2, to which the first touched point in the gesture exemplified in FIG. 14 belongs, may be projected on the merged projection area P.

That is, as shown in FIG. 15, when an arbitrary point of the second projection area P-2 is first touched, followed by a touch on an arbitrary point of the first projection area P-1, and the two points are moved in a direction closer to each other to be merged, the divided projection areas are merged, and the image projected onto the second projection area P-2, which is first-touched, may be projected onto the merged projection area P. This is merely an example, and the image to be projected may be determined by various methods.

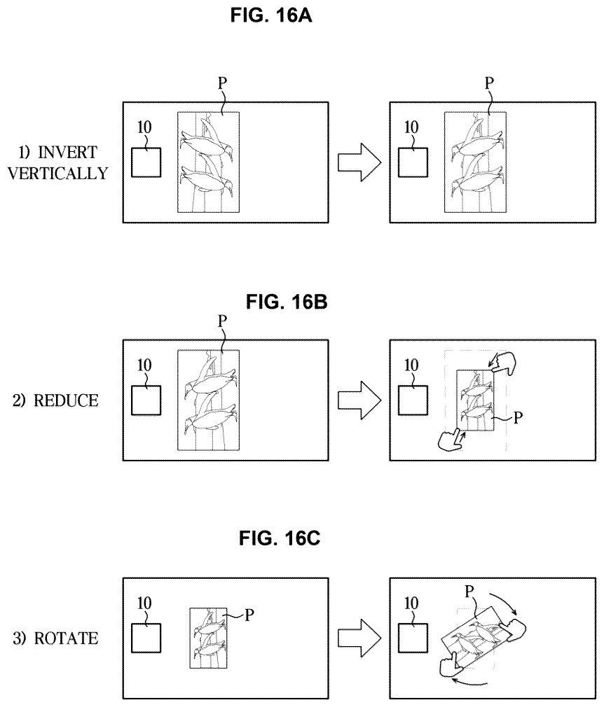

FIGS. 16A to 16C are diagrams illustrating various examples of adjusting a projection area according to an embodiment.

The projection area before division, each of the divided projection areas, and the projection area merged back after the division may all be adjusted by a predetermined gesture input. That is, the controller 50 may, in response to the gesture input being an adjustment command for the projection area P, may control the projection adjuster 30 such that the projection area P is vertically inverted, enlarged or reduced, or rotated.

FIGS. 16A and 16B illustrate the projection area before division or the merged projection area as an example; however, the disclosure is not limited thereto.

As shown in FIG. 16A, in response to a gesture input for vertically inverting the projection area P, the image projected onto the projection area P may be vertically inverted. Also, in response to a predetermined gesture input, the image projected onto the projection area P may be horizontally inverted, or both vertically and horizontally inverted.

As shown in FIG. 16B, in response to a gesture input for reducing the projection area P, the projection area P may be reduced, and accordingly, the image projected onto the projection area P may also be reduced. Further, in response to a predetermined gesture input, the projection area P may be enlarged, and accordingly, the image projected onto the projection area P may also be enlarged.

As shown in FIG. 16C, in response to a gesture input for rotating the projection area P, the projection area P may be rotated, and accordingly, the image projected onto the projection area P may also be rotated.

The adjustment of vertically inverting, enlarging or reducing, or rotating the projection area P is merely an example, and more diverse adjustments of the projection area P may be performed.

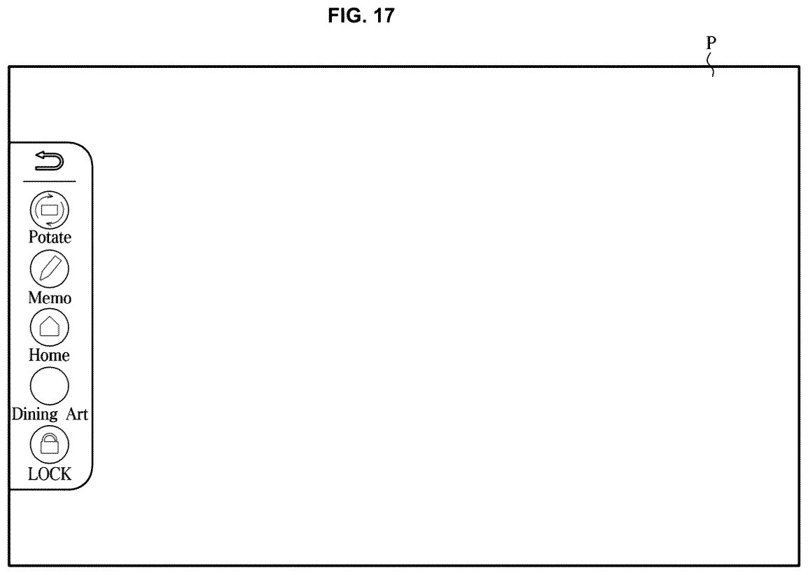

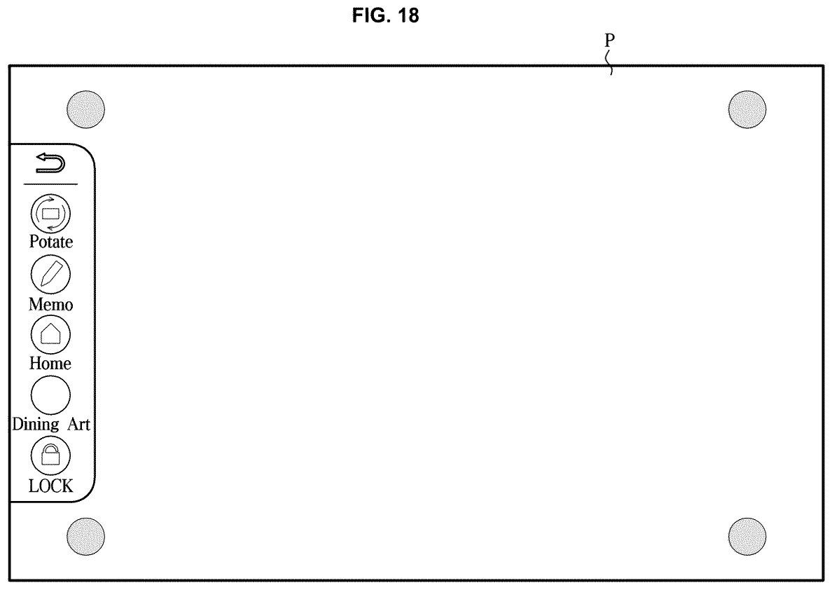

FIG. 17 is a diagram illustrating a user interface for adjusting a projection area according to an embodiment, and FIG. 18 is a diagram illustrating a user interface for adjusting a projection area according to an embodiment.

Although a predetermined gesture may be input to adjust the projection area P, the adjustment of the projection area P may also be performed by touching a user interface provided in the projection area P.

FIG. 17 illustrates a user interface provided in a region of the projection area P. This may be a quick menu for adjusting the projection area P.

A user may select “Rotate” to rotate the projection area P. The user may also select “Memo” to open a memo window for touch input memos. The user may also select “Home” to return to the initial screen, or select “Lock” to stop detecting gesture inputs. Details of “Dining Art” will be described below.

As shown in FIG. 18, a specific form of interface may be provided around each corner of the projection area P to allow the user to more easily adjust the projection area P. When multiple projections areas P are projected, the specific form of interface may be provided around each corner of each projection area P for each user to more easily adjust a corresponding protection area P. Various touch inputs on the four circular interfaces shown in FIG. 18 may be used to perform adjustments, such as enlarging/reducing or rotating the projection area P.

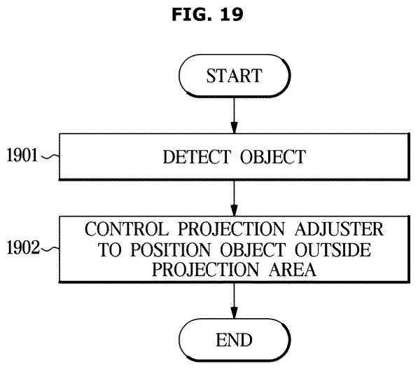

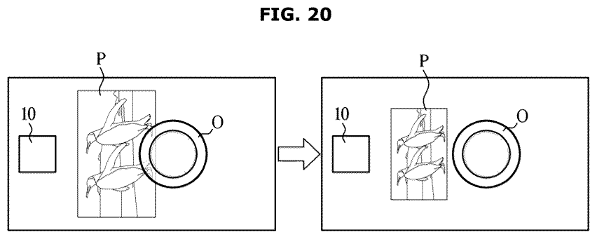

FIG. 19 is a flowchart illustrating adjustment of a projection area based on a detected object according to an embodiment. FIG. 20 is a diagram illustrating adjustment of a projection area based on a detected object according to an embodiment.

The above description pertains to a case in which no separate object O is present on the surface, such as a table, on which the projection area P is formed.

When a separate object O is present on the projection surface, the projected image may be distorted, causing inconvenience to the user when viewing the projected image. Accordingly, the projector 10 may further include a detector 70 configured to detect the object O, and project an image while avoiding the object by detecting the object O.

That is, the detector 70 may detect the object O (1901), and the controller 50 may control the projection adjuster 30 such that the object O detected by the detector 70 is positioned outside the projection area P (1902).

Referring to FIG. 20, when the projector 10 projects an image toward a surface such as a table, an object O, such as a plate may be present nearby.

The detector 70 may detect such a plate, and the controller 50 may control the projection such that the image is projected without overlapping with the plate.

This may be applied regardless of the projection area before division, each of the divided projection areas, and the merged projection area. For example, when a gesture input for dividing the projection is detected, the controller 50 may control the projection adjuster 30 such that the divided projection areas avoid overlapping with the object O. Similarly, when a gesture input for merging the divided projection areas is detected, the controller 50 may control the projection adjuster 30 to merge the divided projection areas into a merged projection area and project the merged projection area so as to not overlap with the object O.

By detecting the object O and adjusting the projection area P such that the object O is located outside the projection area P, a situation, in which an image is projected onto the object O and distorted, may be prevented, thereby enhancing user convenience. For example, the

The above description pertains to dividing the projection area P projected by the projector 10 and adjusting the projection area P. The following describes an operation in which an object O is detected and an image is projected around the corresponding object O to form an aesthetic sense.

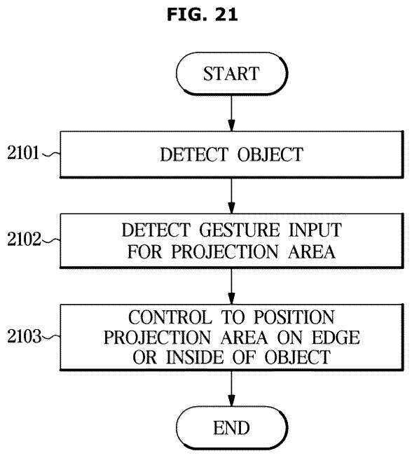

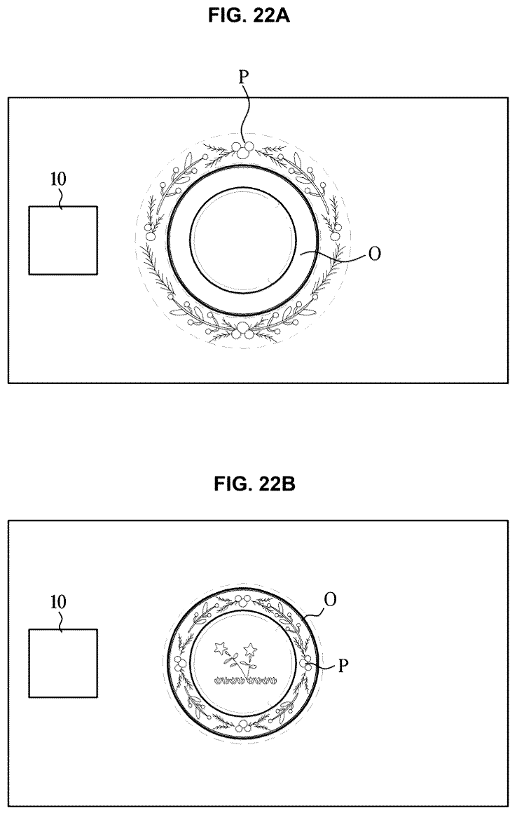

FIG. 21 is a flowchart illustrating projection of an image based on a detected object according to some embodiments, and FIGS. 22A and 22B are diagrams illustrating an image being projected onto the edge or inside of an object according to an embodiment.

The projector 10 may include an image generator 20 that generates an image, a projection adjuster 30 that adjusts a projection area P in which the generated image is projected, a sensor 40 that detects a gesture input for the projection area P, and a detector 70 that detects an object O.

The controller 50 may control the projection adjuster 30 such that the projection area P is positioned on the edge of the object O or inside the object O based on a gesture input for the projection area P.

Here, the object O may include a plate. That is, the controller 50 may control the projection adjuster 30 such that the projection area P is positioned on the edge of the plate or inside the plate based on a gesture input.

By projecting an image onto the periphery of tableware, such as a plate as described above, a decorative effect may be provided, allowing the user to experience an aesthetic impression. This may be the operation that occurs when a user selects “Dining Art” in FIG. 17 described above.

Referring to FIG. 22A, it can be seen that a decorative effect is generated by projecting an image onto the periphery of a plate.

Specifically, in FIG. 22A, the projection area P may be positioned on the edge of the plate, and a specific image capable of providing an aesthetic impression may be projected to give an appearance of a specific pattern of decoration formed on the edge of the plate.

Also, in FIG. 22B, the projection area P may be positioned inside the plate, and a specific image capable of providing an aesthetic impression may be projected to give an appearance of a specific pattern of decoration formed inside the plate.

Although the example illustrates projecting an image on the edge or inside of a plate to provide decoration, the disclosure is not limited thereto, and an image may be projected in various forms to provide an aesthetic impression.

By detecting an object O, such as a plate and projecting an image on the edge or inside of the object O as described above, the user may be allowed to experience an aesthetic impression.

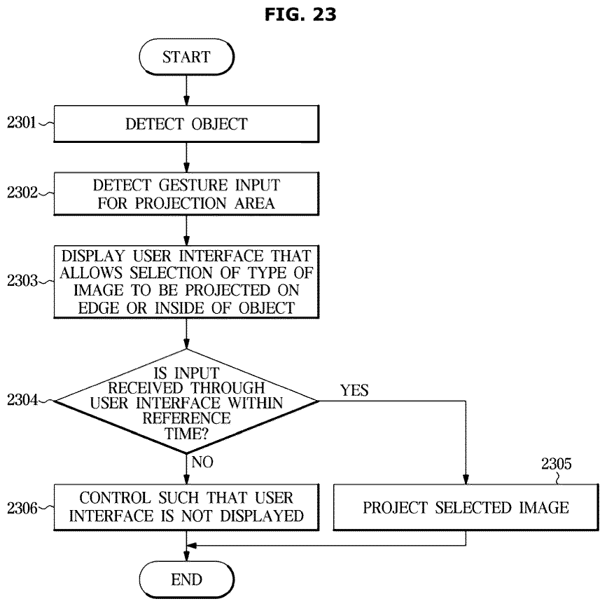

FIG. 23 is a diagram illustrating selection of an image to be projected onto the edge or inside of an object according to an embodiment.

A process of determining an image to be projected when projecting an image on the edge or inside of an object O, such as a plate will be described.

The detector 70 may detect an object O (2301), and when a gesture input for the projection area P is detected (2302), specifically in a situation in which the user has selected “Dining Art” in FIG. 17, the controller 50 may control the projection adjuster 30 to display a user interface that allows selection of the type of an image to be projected onto the edge or inside of the object O (2303).

That is, the controller 50 may, based on the gesture input, control the projection adjuster 30 to display a user interface that allows selection of the type of an image to be projected onto the projection area P located on the edge or inside of the object O.

A button-type interface may be provided such that, when the button is touched, a different image may be projected, or various types of images may be provided such that an image selected by the user may be projected. The disclosure is not limited thereto, and various forms of user interfaces for selecting the type of image to be projected may be displayed.

The controller 50 may, when an input through the user interface is received within a reference time (Yes in operation 2304), control the projection adjuster 30 such that the selected image may be projected (2305). Here, the reference time may be set to an appropriate time for the user to select the image to be projected. For example, the reference time may be an elapsed time from when the user interface is first displayed, or an elapsed time from a time at which a previous input through the user interface was received.

Also, the controller 50 may, when an input through the user interface is not received within the reference time (No in operation 2304), control the projection adjuster 30 such that the user interface is not displayed (2306).

For example, when the above-described button-type user interface is displayed, and a touch on the button is not input within the reference time, the display of the button-type user interface may stopped.

A projector according to an embodiment includes: an image generator configured to generate an image; a projection adjuster configured to adjust a projection area onto which the generated image is projected; a sensor configured to detect a gesture input for the projection area; and a controller configured to, in response to the gesture input being a division command for the projection area, control the projection adjuster such that an image is projected onto the projection area as divided.

According to the disclosure, by recognizing a gesture input on a projection area projected by a projector and dividing a single projection area into a plurality of projection areas, a plurality of users can be allowed to each view a desired image.

The controller may be configured to, in response to the gesture input being the division command for the projection area, control the projection adjuster such that images are projected onto the projection areas divided at different ratios.

The controller may be configured to, based on a gesture input for each of the divided projection areas, control the projection adjuster to adjust each of the divided projection areas.

The controller may be configured to, in response to the gesture input being a merging command for the divided projection areas, control the projection adjuster such that the divided projection areas may be merged into a single projection area.

The projector may further include a camera configured to capture an image of surroundings of the projector, wherein the controller may be configured to determine a number of users based on the image captured by the camera and control the projection adjuster such that images may be projected onto the projection areas divided based on the determined number of users.

According to the disclosure, by recognizing users and automatically dividing the projection area, user convenience can be enhanced.

The projector may further include a detector configured to detect an object, and the controller may be configured to control the projection adjuster such that the object detected by the detector may be positioned outside the projection area.

According to the disclosure, by detecting an object around the projector and allowing an image to be projected onto an area excluding the object, user convenience can be enhanced.

The controller may be configured to, in response to the gesture input being an adjustment command for the projection area, control the projection adjuster to vertically invert, enlarge or reduce, or rotate the projection area.

According to the disclosure, by individually controlling the divided projection areas, each user can view an image in a preferred environment.

A projector according to another embodiment includes: an image generator configured to generate an image; a projection adjuster configured to adjust a projection area onto which the generated image is projected; a sensor configured to detect a gesture input for the projection area; a detector configured to detect an object; and a controller configured to control the projection adjuster such that the projection area is positioned at an edge of the object or inside the object based on the gesture input.

According to the disclosure, by detecting an object around the projector and projecting an image onto an edge or an inside of the object, the user can be provided with an aesthetic impression.

The controller may be configured to control the projection adjuster to display a user interface that allows selection of a type of an image to be projected onto the projection area, which is positioned at the edge of the object or inside the object based on the gesture input.

The controller may be configured to, based on no input being received through the user interface within a reference time, control the projection adjuster such that the user interface is not displayed.

The object may include a plate, and the controller may be configured to, based on the gesture input, control the projection adjuster such that the projection area is positioned at an edge of the plate or inside the plate.

A method of controlling a projector according to an embodiment, which includes an image generator configured to generate an image and a projection adjuster configured to adjust a projection area onto which the generated image is projected, includes: detecting a gesture input for the projection area; and in response to the gesture input being a division command for the projection area, controlling the projection adjuster such that an image is projected onto the projection area as divided.

The controlling of the projection adjuster may include: in response to the gesture input being the division command for the projection area, controlling the projection adjuster such that images are projected onto the projection areas divided at different ratios.

The controlling of the projection adjuster may include: based on a gesture input for each of the divided projection areas, controlling the projection adjuster to adjust each of the divided projection areas.

The controlling of the projection adjuster may include: in response to the gesture input being a merging command for the divided projection areas, controlling the projection adjuster such that the divided projection areas are merged into a single projection area.

The method may further include capturing an image of surroundings of the projector, wherein the controlling of the projection adjuster may include determining a number of users based on the image captured by the camera and controlling the projection adjuster such that images may be projected onto the projection areas divided based on the determined number of users.

The method may further include detecting an object, and the controlling of the projection adjuster may include controlling the projection adjuster such that the detected object may be positioned outside the projection area.

The controlling of the projection adjuster may include, in response to the gesture input being an adjustment command for the projection area, controlling the projection adjuster to vertically invert, enlarge or reduce, or rotate the projection area.

A method of controlling a projector according to another embodiment, which includes an image generator configured to generate an image and a projection adjuster configured to adjust a projection area onto which the generated image is projected, includes: detecting an object; and controlling the projection adjuster such that the projection area is positioned at an edge of the object or inside the object based on the gesture input.

The controlling of the projection adjuster may include controlling the projection adjuster to display a user interface that allows selection of a type of an image to be projected onto the projection area, which is positioned at the edge of the object or inside the object based on the gesture input.

The controlling of the projection adjuster may include, based on no input being received through the user interface within a reference time, controlling the projection adjuster such that the user interface is not displayed.

The object may include a plate, and the controlling of the projection adjuster may include, based on the gesture input, controlling the projection adjuster such that the projection area is positioned at an edge of the plate or inside the plate.

According to an aspect of the disclosure, by recognizing a gesture input for a projection area that is projected, and dividing a single projection area into a plurality of projection areas, a plurality of users can be allowed to each view a desired image.

In addition, by detecting an object around the projector, an image can be allowed to be projected onto an area excluding the object.

According to another aspect of the disclosure, by detecting an object around the projector and projecting an image onto an edge or an inside of the object, the user can be provided with an aesthetic impression.

The disclosed embodiments may be embodied in the form of a non-transitory recording medium storing instructions executable by a computer. The instructions may be stored in the form of program code and, when executed by a processor, may generate a program module to perform the operations of the disclosed embodiments. The recording medium may be embodied as a non-transitory computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A projector comprising:
an image generator configured to generate an image;
a projection adjuster configured to adjust a projection area onto which the image is projected;
a sensor configured to detect a gesture input for the projection area;
memory storing instructions; and
a processor configured to execute the instructions,
wherein the instructions, when executed by the processor, cause the projector to, based on the gesture input being a division command for the projection area, control the projection adjuster such that the image is projected onto divided projection areas as divided.

2. The projector of claim 1, wherein the instructions, when executed by the processor, cause the projector to, based on the gesture input being the division command for the projection area, control the projection adjuster such that the image is projected onto the divided projection areas at different ratios.

3. The projector of claim 1, wherein the instructions, when executed by the processor, cause the projector to, based on a gesture input for each of the divided projection areas, control the projection adjuster to adjust each of the divided projection areas.

4. The projector of claim 1, wherein the instructions, when executed by the processor, cause the projector to, based on the gesture input being a merging command for the divided projection areas, control the projection adjuster such that the divided projection areas are merged into a single projection area.

5. The projector of claim 1, further comprising a camera configured to capture a surrounding image of surroundings of the projector,
wherein the instructions, when executed by the processor, cause the projector to determine a number of users based on the surrounding image captured by the camera and control the projection adjuster such that the image projected onto the projection area is divided into the divided projection areas based on the determined number of users.

6. The projector of claim 1, further comprising a detector configured to detect an object,
wherein the instructions, when executed by the processor, cause the projector to control the projection adjuster such that the projection area does not overlap with the object detected by the detector.

7. The projector of claim 1, wherein the instructions, when executed by the processor, cause the projector to, based on the gesture input being an adjustment command for the projection area, control the projection adjuster to adjust at least one of a position, a size, an orientation, or an angle of the projection area.

8. A projector comprising:
an image generator configured to generate an image;
a projection adjuster configured to adjust a projection area onto which the generated image is projected;
a sensor configured to detect a gesture input for the projection area;
a detector configured to detect an object;
memory storing instructions; and
a processor configured to execute the instructions,
wherein the instructions, when executed by the processor, cause the projector to control, based on the gesture input, the projection adjuster to position the projection area at one of an edge of the object or an inside of the object.

9. The projector of claim 8, wherein the instructions, when executed by the processor, cause the projector to control, based on the gesture input, the projection adjuster to display a user interface that allows selection of a type of image to be projected onto the projection area at the one of the edge of the object or the inside the object.

10. The projector of claim 9, wherein the instructions, when executed by the processor, cause the projector to, based on no input being received through the user interface within a reference time, control the projection adjuster to stop the display of the user interface.

11. The projector of claim 8, wherein the object comprises a plate, and wherein the instructions, when executed by the processor, cause the projector to control, based on the gesture input, the projection adjuster to position the projection area at the edge of the plate or on the inside the plate.

12. A method of controlling a projector, the method comprising:
generating an image;
projecting the image onto a projection area;
detecting a gesture input for the projection area; and
based on the gesture input being a division command for the projection area, dividing the projection area such that the image is projected onto divided projection areas.

13. The method of claim 12, wherein the dividing comprises:
dividing the projection area such that the image is projected onto the divided projection areas at different ratios.

14. The method of claim 12, further comprising:
based on an adjustment gesture input being detected on each of the divided projection areas, adjusting each image projected on each of the divided projection areas.

15. The method of claim 12, further comprising:
based on a merging gesture input being detected for the divided projection areas, merging the divided projection areas into a single projection area.

16. The method of claim 12, further comprising capturing an image of surroundings of the projector,
wherein the diving the projection area comprises:
determining a number of users based on the image; and
dividing the projection area such that images are projected onto the projection areas divided based on the number of users.

17. The method of claim 12, further comprising detecting an object, and the controlling of the projection adjuster may include controlling the projection adjuster such that the detected object may be positioned outside the projection area.

18. The method of claim 12, the dividing the projection area comprises, based on the gesture input being an adjustment command for the projection area, adjusting at least one of a position, a size, an orientation, or an angle of the projection area.
